(19) United States
(12) Patent Application Publication
(10) Pub. No.: US 2021/0320303 A1
(43) Pub. Date: Oct. 14, 2021

(54) STYRENE-BASED COPOLYMER FOR ELECTRODE BINDER OF SOLID ALKALINE FUEL CELL AND MEMBRANE ELECTRODE ASSEMBLY COMPRISING THE SAME

(71) Applicant: KOREA INSTITUTE OF SCIENCE AND TECHNOLOGY, Seoul (KR)

(72) Inventors: Hyoung-Juhn KIM, Seoul (KR); Ji Eon CHAE, Seoul (KR); So Young LEE, Seoul (KR); Hee-Young PARK, Seoul (KR); Jin Young KIM, Seoul (KR); Jong Hyun JANG, Seoul (KR); Hyun Seo PARK, Seoul (KR); Sung Jong YOO, Seoul (KR)

(73) Assignee: KOREA INSTITUTE OF SCIENCE AND TECHNOLOGY, Seoul (KR)

(21) Appl. No.: 16/901,127

(22) Filed: Jun. 15, 2020

(30) Foreign Application Priority Data
Apr. 8, 2020 (KR) 10-2020-0042678

(51) Int. Cl. H01M 4/86; H01M 4/88; C08F 212/14

(52) U.S. Cl. CPC H01M 4/8668; H01M 4/881; H01M 2008/1095; C08F 212/28; H01M 4/8828

(57) ABSTRACT

The present disclosure relates to a styrene-based copolymer for an electrode binder of a solid alkaline fuel cell, represented by the following Chemical Formula 1, an electrode binder including the same, and a membrane electrode assembly including the electrode binder. The electrode binder for a solid alkaline fuel cell is obtained by dispersing the styrene-based copolymer for an electrode binder in a mixed solvent of alcohol with water. Thus, even when coating electrode catalyst slurry including the electrode binder directly on an electrolyte membrane, the electrolyte membrane is not damaged so that the quality of a solid alkaline fuel cell using the same may be improved.

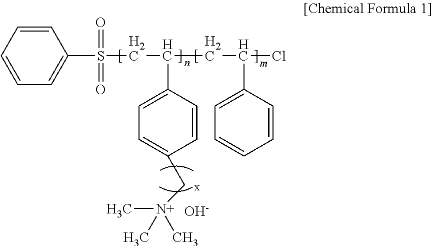

wherein x is an integer of 2-10, and
each of m and n represents the number of repeating units.

### CROSS-REFERENCE TO RELATED APPLICATIONS

This application claims, under 35 U.S.C. § 119, the priority of Korean Patent Application No. 10-2020-0042678 filed on Apr. 8, 2020 in the Korean Intellectual Property Office, the disclosure of which is incorporated herein by reference in its entirety.

### TECHNICAL FIELD

The following disclosure relates to a styrene-based copolymer for an electrode binder of a solid alkaline fuel cell, an electrode binder including the same, a membrane electrode assembly including the electrode binder, and a solid alkaline fuel cell including the membrane electrode assembly and a method for manufacturing the same.

### BACKGROUND

Many attempts have been made to develop eco-friendly and sustainable power generation systems in order to solve the problems of green gas and use of fossil fuel that cause a climate change as a worldwide concern. In this context, development of eco-friendly low-cost alkaline fuel cells having excellent power generation efficiency have been conducted actively. Particularly, intensive studies have been conducted recently about solid alkaline fuel cells driven by using a solid polymer electrolyte as a porous separator of a conventional alkaline fuel cell. The solid electrolyte of a solid alkaline fuel cell can reduce gas permeation significantly and allows load operation, and thus can be used as a fuel cell for transport. In addition, the solid alkaline fuel cell uses an inexpensive electrolyte and is operated under an alkaline condition, and thus is advantageous in that it allows use of inexpensive catalysts, such as silver or nickel catalysts. Therefore, it is highly likely that such a solid alkaline fuel cell can be used as a fuel cell for transport.

Currently, in the case of solid alkaline fuel cells, many studies have been conducted about electrolyte membranes and low-cost catalysts. However, studies about an electrode binder, one of main ingredients of a membrane electrode assembly, have almost never been conducted. The electrode binder of a solid alkaline fuel cell functions to interconnect catalyst particles, to perform adhesion with an electrolyte membrane and to transport hydroxide (OH⁻) ions in an electrode.

A membrane electrode assembly is obtained largely through the two methods. The first method is a catalyst coated on GDM (CCG) method, wherein an electrode is applied to a gas diffusion medium (GDM) and the resultant product is hot pressed with an electrolyte membrane. The second method is a catalyst coated on membrane (CCM) method, wherein an electrode is coated on a release film (e.g. Teflon) and then transferred to an electrolyte membrane. In both cases, the binder ingredients and constitution of a binder dispersion for dispersing the same are very important.

According to the related art, the electrode binder cannot be dispersed in a mixture of alcohol with water, and thus is used after being dissolved in DMAc or DMF. For this, when catalyst slurry including the electrode binder is prepared and sprayed to an electrolyte membrane, the electrolyte membrane may be damaged. Therefore, there is a problem in that it is difficult to spray the catalyst slurry directly to the electrolyte membrane.

### REFERENCES

### Patent Documents

Korean Patent Publication No. 10-1392230

### SUMMARY

The present disclosure is designed to solve the problems of the related art, and an embodiment of the present disclosure is directed to providing a styrene-based copolymer for an electrode binder of a solid alkaline fuel cell which has a controlled molecular weight to be dissolved in a mixed solvent of alcohol with water so that use of an organic solvent, such as DMAc or DMF, which may cause damages upon an electrolyte membrane, as an electrode binder ingredient may be avoided and only a mixed solvent of alcohol with water may be used.

In addition, the present disclosure is directed to providing an electrode binder for a solid alkaline fuel cell prepared by dispersing the styrene-based copolymer for an electrode binder of a solid alkaline fuel cell in a mixed solvent of alcohol with water, and thus causing no damages upon an electrolyte membrane, even when electrode catalyst slurry including the electrode binder is coated directly on the electrolyte membrane, and ultimately capable of improving the quality of a solid alkaline fuel cell using the electrode binder. The present disclosure is also directed to providing a membrane electrode assembly including the electrode binder for a solid alkaline fuel cell.

Further, the present disclosure is directed to providing a solid alkaline fuel cell having improved quality, such as power density, by applying the membrane electrode assembly to a solid alkaline fuel cell.

In one aspect of the present disclosure, there is provided a styrene-based copolymer for an electrode binder of a solid alkaline fuel cell, represented by the following Chemical Formula 1:

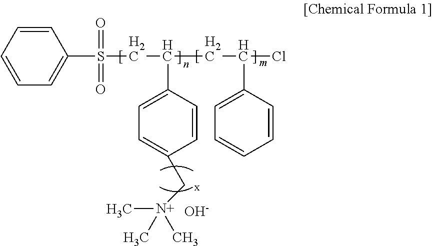

wherein x is an integer of 2-10, and

each of m and n represents the number of repeating units.

The styrene-based copolymer represented by Chemical Formula 1 may have a molecular weight (Mₙ) of 5,000-200,000 g/mol.

In the styrene-based copolymer, OH⁻ containing units may be present at 30-60% based on the number of total units.

The styrene-based copolymer may show peaks at 7.55-7.36 ppm, 7.32-6.19 ppm, 3.39-3.19 ppm, 3.13-2.97 ppm, 2.57-2.31 ppm and 1.71-1.10 ppm in ¹H-NMR analysis.

In another aspect of the present disclosure, there is provided an electrode binder for a solid alkaline fuel cell which includes the styrene-based copolymer for an electrode binder of a solid alkaline fuel cell.

The electrode binder may be present as dispersion containing the styrene-based copolymer dispersed in a mixed solvent of alcohol with water.

The mixed solvent may include 25-400 parts by weight of water based on 100 parts by weight of alcohol.

In still another aspect of the present disclosure, there is provided a membrane electrode assembly for a solid alkaline fuel cell which includes an electrolyte membrane, and a catalyst layer coated on the electrolyte membrane, wherein the catalyst layer includes the electrode binder for a solid alkaline fuel cell.

In still another aspect of the present disclosure, there is provided a solid alkaline fuel cell including the membrane electrode assembly.

In still another aspect of the present disclosure, there is provided a method for preparing a styrene-based copolymer for an electrode binder of a solid alkaline fuel cell, including the steps of:

(1) polymerizing a styrene-based polymer;

(2) substituting a part of phenyl groups of the styrene-based polymer with acyl groups to obtain an acyl group-substituted styrene-based polymer;

(3) reducing ketone groups of the acyl group-substituted styrene-based polymer to obtain a ketone group-reduced styrene-based polymer; and

(4) substituting the ketone group-reduced styrene-based polymer with quaternary ammonium to obtain a quaternary ammonium-substituted styrene-based polymer.

After step (4), the method may further include step (5) of reacting the quaternary ammonium-substituted styrene-based polymer with an aqueous basic solution so that the halogen ions ionically bound to quaternary ammonium may be substituted with hydroxide ions (OH⁻), thereby providing a styrene-based copolymer represented by the following Chemical Formula 1:

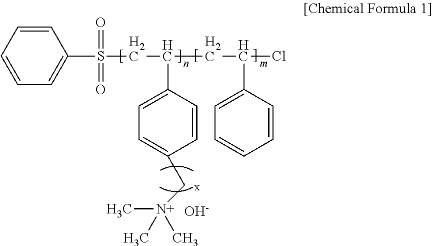

wherein x is an integer of 2-10, and

each of m and n represents the number of repeating units.

In step (1), the polymerization may be carried out by any one of leaving radical polymerization, anion polymerization and cation polymerization.

In step (3), the reduction of ketone groups may be carried out by dissolving the acyl group-substituted styrene-based polymer in 1,2-dichloroethane and carrying out reaction with trifluoroacetic acid and triethylsilane.

After completing the reduction of ketone groups, a step of mixing the resultant product with a basic solution to perform neutralization may be further carried out.

In still another aspect of the present disclosure, there is provided a method for preparing an electrode binder for a solid alkaline fuel cell which includes the method for preparing a styrene-based copolymer for an electrode binder of a solid alkaline fuel cell.

Preferably, the method for preparing a styrene-based copolymer for an electrode binder of a solid alkaline fuel cell may include a step of dispersing the styrene-based copolymer in a mixed solvent of alcohol with water.

In still another aspect of the present disclosure, there is provided a method for manufacturing a membrane electrode assembly for a solid alkaline fuel cell which includes the method for preparing an electrode binder for a solid alkaline fuel cell.

Particularly, the method for manufacturing a membrane electrode assembly for a solid alkaline fuel cell may include the steps of: mixing the electrode binder for a solid alkaline fuel cell, a catalyst, water and a solvent to prepare catalyst electrode slurry; and coating the catalyst electrode slurry directly on an electrolyte membrane to obtain a membrane electrode assembly.

The coating may be carried out by any one coating process selected from spray coating, catalyst coated membrane (CCM) coating and catalyst coated gas diffusion media (CCG) coating.

In yet another aspect of the present disclosure, there is provided a method for manufacturing a solid alkaline fuel cell which includes the method for manufacturing a membrane electrode assembly for a solid alkaline fuel cell.

The styrene-based copolymer for an electrode binder of a solid alkaline fuel cell has a molecular weight controlled adequately through leaving radical polymerization etc., so that use of an organic solvent, such as DMAc or DMF, which may cause damages upon an electrolyte membrane, as an electrode binder ingredient may be avoided and only a mixed solvent of alcohol with water may be incorporated, and thus can be dispersed well in a mixed solvent of alcohol with water.

In addition, according to the electrode binder for a solid alkaline fuel cell and the membrane electrode assembly disclosed herein, the electrode binder for a solid alkaline fuel cell is obtained by dispersing the styrene-based copolymer for an electrode binder of a solid alkaline fuel cell in a mixed solvent of alcohol with water. Therefore, even when coating the electrode catalyst slurry containing the electrode binder directly on an electrolyte membrane, the electrolyte membrane is not damaged, resulting in improvement of the quality of a solid alkaline fuel cell using the membrane electrode assembly.

### BRIEF DESCRIPTION OF THE DRAWINGS

FIG. 1 illustrates the process of synthesizing the styrene-based copolymer according to Example 1.

FIG. 2 is a photographic view illustrating the electrode binder obtained from Example 2.

FIG. 3 illustrates the results of ¹H-NMR analysis according to Test Example 1.

FIG. 4 shows a current-voltage graph and current-power graph of the solid alkaline fuel cell according to Test Example 2.

### DETAILED DESCRIPTION OF EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. In addition, it will be apparent to those skilled in the art that various changes, equivalents and substitutes may be made based on the disclosure of the present invention and are also within the scope of the present disclosure as defined in the following claims. In the description, details of well-known features and techniques may be omitted to avoid unnecessarily obscuring the presented embodiments.

Hereinafter, the styrene-based copolymer for an electrode binder of a solid alkaline fuel cell will be explained in more detail.

In one aspect of the present disclosure, there is provided a styrene-based copolymer for an electrode binder of a solid alkaline fuel cell, represented by the following Chemical Formula 1:

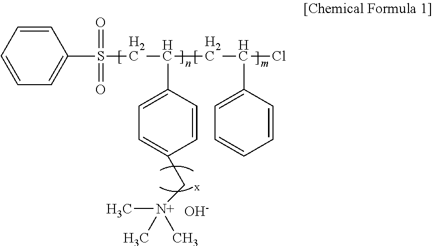

wherein x is an integer of 2-10, and

each of m and n represents the number of repeating units.

Preferably, the styrene-based copolymer represented by Chemical Formula 1 may have a molecular weight (Mₙ) of 5,000-200,000 g/mol, more preferably 30,000-100,000 g/mol.

When the molecular weight of the styrene-based copolymer is smaller than the lower limit, adhesion to the electrolyte membrane may be degraded or hydroxide ion transportability in the electrode may be decreased, and thus it is difficult to perform the functions as an electrode binder or electrolyte. When the molecular weight of the styrene-based copolymer is larger than the upper limit, such an excessively high molecular weight makes it difficult to carry out dispersion in a mixed solvent of alcohol with water, and thus the styrene-based copolymer may not be suitable for application to an electrode binder.

Particularly, in the styrene-based copolymer, OH⁻ containing units may be present at 30-60% based on the number of total units.

The styrene-based copolymer may be synthesized through leaving radical polymerization but it may be synthesized with a controlled molecular weight through anion polymerization or cation polymerization.

The styrene-based copolymer may show peaks at 7.55-7.36 ppm, 7.32-6.19 ppm, 3.39-3.19 ppm, 3.13-2.97 ppm, 2.57-2.31 ppm and 1.71-1.10 ppm in ¹H-NMR analysis.

In another aspect of the present disclosure, there is provided an electrode binder for a solid alkaline fuel cell which includes the styrene-based copolymer for an electrode binder of a solid alkaline fuel cell.

The electrode binder is an electrolyte which interconnects catalyst particles, is adhered to an electrolyte membrane and transports hydroxide ions in an electrode. A styrene-based polymer has higher gas permeability as compared to the conventional electrolytes.

The electrode binder may be present as dispersion containing the styrene-based copolymer dispersed in a mixed solvent of alcohol with water.

The mixed solvent may include 25-400 parts by weight of water based on 100 parts by weight of alcohol. Particularly, the mixed solvent may include 30-200 parts by weight, more particularly 35-100 parts by weight of water, based on 100 parts by weight of alcohol. When the above-defined range is not satisfied, the polymer may not be dispersed in the solvent or may be dispersed non-homogeneously due to high viscosity undesirably.

In still another aspect of the present disclosure, there is provided a membrane electrode assembly for a solid alkaline fuel cell, including: an electrolyte membrane; and a catalyst layer coated on the electrolyte membrane, wherein the catalyst layer includes the above-described electrode binder for a solid alkaline fuel cell.

The catalyst contained in the catalyst layer may include at least one selected from Ni, Ag, Cu and Pt, and particularly relatively low-cost Ni, Ag, Cu, or the like, may be used. Since the solid alkaline fuel cell is operated under alkaline environment, there is an advantage in that use of a platinum-based catalyst showing high activity under acidic atmosphere is not required, unlike the conventional polymer electrolyte fuel cell.

In still another aspect of the present disclosure, there is provided a solid alkaline fuel cell including the above-described membrane electrode assembly for a solid alkaline fuel cell.

Hereinafter, the method for preparing a styrene-based copolymer for an electrode binder of a solid alkaline fuel cell will be explained.

First, a styrene-based polymer is polymerized (step 1).

The polymerization may be carried out by any one of leaving radical polymerization, anion polymerization and cation polymerization. The styrene-based copolymer may be controlled to have a molecular weight suitable for an electrolyte of an electrode binder.

Next, a part of phenyl groups of the styrene-based polymer is substituted with acyl groups to obtain an acyl group-substituted styrene-based polymer (step 2).

Then, ketone groups of the acyl group-substituted styrene-based polymer are reduced to obtain a ketone group-reduced styrene-based polymer (step 3).

The reduction of ketone groups may be carried out by dissolving the acyl group-substituted styrene-based polymer in 1,2-dichloroethane and carrying out reaction with trifluoroacetic acid and triethylsilane.

After completing the reduction of ketone groups, a step of mixing the resultant product with a basic solution to perform neutralization may be further carried out.

After that, the ketone group-reduced styrene-based polymer is substituted with quaternary ammonium to obtain a quaternary ammonium-substituted styrene-based polymer (step 4).

Finally, the quaternary ammonium-substituted styrene-based polymer is allowed to react with an aqueous basic solution so that the halogen ions ionically bound to quaternary ammonium may be substituted with hydroxide ions (OH⁻), thereby providing a styrene-based copolymer represented by the following Chemical Formula 1 (step 5):

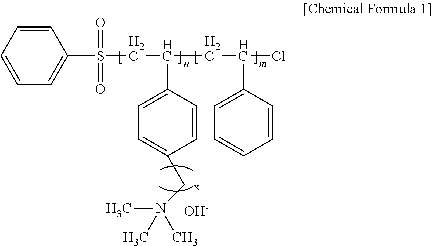

wherein x is an integer of 2-10, and

each of m and n represents the number of repeating units.

In still another aspect of the present disclosure, there is provided a method for preparing an electrode binder for a solid alkaline fuel cell which includes the method for preparing a styrene-based copolymer for an electrode binder of a solid alkaline fuel cell.

The method for preparing a styrene-based copolymer for an electrode binder of a solid alkaline fuel cell may include a step of dispersing the styrene-based copolymer in a mixed solvent of alcohol with water.

In still another aspect of the present disclosure, there is provided a method for manufacturing a membrane electrode assembly for a solid alkaline fuel cell which includes the method for preparing an electrode binder for a solid alkaline fuel cell.

Particularly, the method may be carried out by mixing the electrode binder for a solid alkaline fuel cell, a catalyst, water and a solvent to prepare catalyst electrode slurry, and coating the catalyst electrode slurry directly on an electrolyte membrane to obtain a membrane electrode assembly.

The solvent that may be used herein may include isopropanol, toluene, ethanol, n-propanol, n-butyl acetate, ethylene glycol, butyl carbitol (BC), butyl carbitol acetate (BCA), or the like.

The coating may be carried out by any one coating process selected from spray coating, catalyst coated membrane (CCM) coating and catalyst coated gas diffusion media (CCG) coating.

The electrode binder uses no DMAc or DMF used conventionally according to the related art and the polymer electrolyte is dispersed in a mixed solvent of alcohol with water. Therefore, even when coating the electrode catalyst slurry containing the electrode binder directly on an electrolyte membrane, the electrolyte membrane is not damaged, resulting in improvement of the quality of a solid alkaline fuel cell using the membrane electrode assembly.

In yet another aspect of the present disclosure, there is provided a method for manufacturing a solid alkaline fuel cell including the method for manufacturing a membrane electrode assembly for a solid alkaline fuel cell.

The examples and experiments will now be described. The following examples and experiments are for illustrative purposes only and not intended to limit the scope of this disclosure. In addition, it will be apparent to those skilled in the art that various changes and modifications may be made without departing from the spirit and scope of the invention as defined in the following claims.

### EXAMPLES

### Example 1: Synthesis of Styrene-Based Copolymer

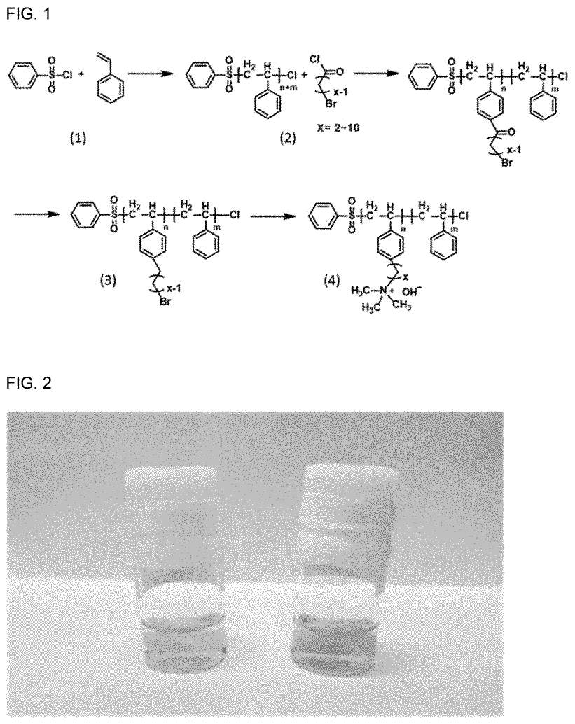

FIG. 1 illustrates the process of synthesizing the styrene-based copolymer according to Example 1. Example 1 will be explained hereinafter with reference to FIG. 1.

(1) Preparation of Styrene-Based Polymer

Styrene monomer prepared by passing it through an alumina column to remove a polymerization inhibitor, benzene sulfonyl chloride as a chain transfer agent and azobisiosbutyronitrile (AIBN) as an initiator were introduced to a Schrenk tube and dissolved in toluene as a solvent. The resultant mixture was sufficiently subjected to degassing in a free-pump thaw mode to remove the dissolved gases, and the Schrenk tube was filled with argon gas and heated to 60° C. The reaction mixture was agitated while maintaining the temperature for 24 hours. After the completion of the reaction, the reaction solution was precipitated with methanol to obtain a polymer having a styrene backbone. The resultant product was washed with methanol many times, and the precipitated polymer was filtered and dried completely in a vacuum oven at 80° C.

(2) Preparation of Acyl Group-Substituted Styrene-Based Polymer

The dried polymer having a styrene backbone was dissolved in 1,2-dichloroethane and acylation was carried out by using aluminum chloride and 6-bromohexanoyl chloride. At room temperature under argon gas atmosphere, the reaction mixture was agitated for 4 hours to complete the reaction. The reaction solution was precipitated with methanol to obtain an acyl group-substituted styrene polymer. The resultant product was washed many times to filter the precipitated polymer and dried completely in a vacuum oven at 80° C.

(3) Reduction of Ketone Groups

The dried acyl group-substituted styrene-based polymer was dissolved in 1.2-dichloroethane, and subjected to reduction of ketone groups with trifluoroacetic acid and triethylsilane. The mixed solution was agitated at 60° C. for 30 hours under reflux. When the reaction was completed, the acidic reaction solution was mixed with 2M aqueous potassium hydroxide solution until it was neutralized. The mixed solution was agitated at 60° C. for 8 hours. After the completion of the reaction, the solution was precipitated with methanol to obtain a styrene polymer in which ketone groups were reduced into alkyl groups. The resultant product was washed many times to filter the precipitated polymer and dried completely in a vacuum oven at 80° C.

(4) Substitution with Trimethylammonium Ions

The dried ketone group-reduced polymer was dissolved in dimethyl formamide and trimethyl amine solution was introduced thereto. Then the resultant mixture was agitated at 60° C. for 16 hours. After the completion of the reaction, the reaction solution was subjected to filtering with a 0.45 micron Teflon syringe to remove impurities. The resultant product was poured to a glass petri dish and the solvent was allowed to evaporate to obtain a desired styrene-based copolymer.

### Example 2: Preparation of Electrode Binder

To obtain a 5 wt % electrode binder, 0.05 g of the styrene-based copolymer obtained according to Example 1 was introduced to a mixed alcohol solution containing 0.665 g of 1-propanol and 0.285 g of distilled water, and dispersed therein through agitation at 40° C.

FIG. 2 is a photographic view of the electrode binder obtained according to Example 2. It can be seen that the electrode binder is transparent.

### Example 3: Manufacture of Membrane Electrode Assembly for Solid Alkaline Fuel Cell

Catalyst electrode slurry was obtained by using 111.32 mg of the electrode binder according to Example 2, 12.99 mg of 46.2 wt % Pt/C (Tanaka), 50 mg of distilled water and 2.5 μL of isopropanol. In addition, FAA-3-20 polymer electrolyte membrane available from Pumatec was used as an electrolyte membrane.

A membrane electrode assembly was obtained by coating a catalyst layer with an area of 5 cm² on the electrolyte membrane through a catalyst coated membrane (CCM) process so that the content of the platinum catalyst per unit area might be 0.4 mg/cm². Then, the resultant membrane electrode assembly was dipped in 1M aqueous potassium hydroxide solution for 4 hours in order to substitute Br⁻ ions of the binder in the electrolyte membrane and catalyst layer with OH⁻ ions. After the completion of the ion substitution, the resultant product was washed many times with argon gas-purged distilled water to remove the remaining OH⁻ ions.

### Comparative Example 1: Manufacture of Membrane Electrode Assembly for Solid Alkaline Fuel Cell

A membrane electrode assembly was obtained in the same manner as Example 3, except that a commercially available binder, AS-4 binder (Dokuyama), was used instead of the electrode binder according to Example 2.

### TEST EXAMPLES

### Test Example 1: ¹H-NMR Analysis Results

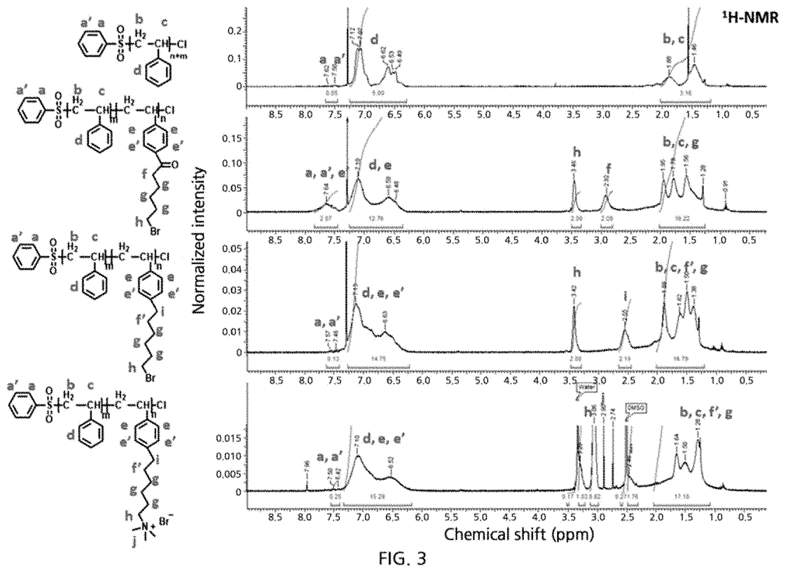

FIG. 3 illustrates the ¹H-NMR analysis results of the polymer in each of steps (1) to (4) according to Example 1. To carry out the analysis, 400 MHz NMR was used. Each of the polymers obtained from steps (1)-(3) was dissolved in CDCl₃ as a solvent to prepare NMR samples, and the polymer obtained from step (4) was dissolved in DMSO-d₆ to prepare its NMR sample.

After the analysis, in step (1), the hydrogen peaks of benzene sulfonyl group at the terminal end of the polymer and the hydrogen peaks of styrene could be identified (Ha, Ha′ 7.66-7.40 ppm; Hd 7.27-6.25 ppm; Hb, Hc 2.03-0.18 ppm).

In step (2), it could be seen that He-Hh peaks were generated, while styrene was substituted with acryl groups (Ha′, He 7.85-7.45 ppm; Hd, He 7.25-6.35 ppm; Hh 3.51-3.34 ppm; Hf 3.02-2.81 ppm; Hb, Hc, Hg 2.02-1.25 ppm).

In step (3), it could be seen from a shift of He′ peak and generation of Hi peak that reduction was carried out sufficiently, while ketone groups were reduced (Ha, Ha′ 7.63-7.41 ppm; Hd, He, He′ 7.27-6.22 ppm; Hh 3.48-3.29 ppm; Hi 2.69-2.43 ppm; Hb, Hc, Hf′, Hg 2.01-1.20 ppm).

In step (4), it could be seen that Hj peak was generated, while the polymer was substituted with quaternary ammonium (Ha, Ha′ 7.55-7.36 ppm; Hd, He, He′ 7.32-6.19 ppm; Hh 3.39-3.19 ppm; Hj 3.13-2.97 ppm; Hi 2.57-2.31 ppm; Hb, Hc, Hf′, Hg 1.71-1.10 ppm).

### Test Example 2: Analysis of Quality of Solid Alkaline Fuel Cell

Each of the membrane electrode assemblies according to Example 3 and Comparative Example 1 was used to evaluate the quality of a solid alkaline fuel cell. To carry out evaluation, humidified hydrogen and oxygen were supplied to an anode and a cathode, respectively, and the cell was set to a temperature of 60° C. While electric current was increased from 0 A by 0.05 A, voltage was measured at each current value to determine current density and power density.

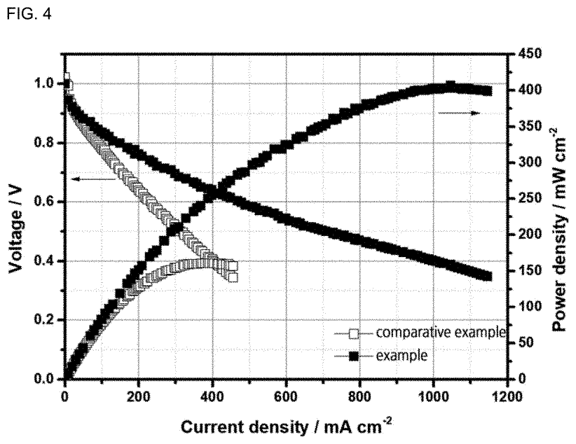

FIG. 4 shows the current-voltage graph and current-power graph obtained from the evaluation. Herein, X-axis represents current density per unit area (mA/cm²), the left-side Y-axis represents voltage (V) and the right-side Y-axis represents power density (mW/cm²). It can be seen that when the membrane electrode assembly according to Example 3 is used to obtain a fuel cell, the maximum power density is about 400 mW/cm², which is significantly higher as compared to the fuel cell using the commercially available membrane electrode assembly. Considering the above-mentioned current-voltage characteristics, it can be seen that the membrane electrode assembly according to the present disclosure is very useful for improving the quality of a solid alkaline fuel cell.

While the present disclosure has been described with respect to the specific embodiments, it will be apparent to those skilled in the art that various changes and modifications may be made through addition, modification or elimination without departing from the spirit and scope of the disclosure as defined in the following claims.

1. A method for preparing an electrode binder of a solid alkaline fuel cell, comprising the steps of:
(1) polymerizing a styrene-based polymer;
(2) substituting a part of phenyl groups of the styrene-based polymer with acyl groups to obtain an acyl group-substituted styrene-based polymer;
(3) reducing ketone groups of the acyl group-substituted styrene-based polymer to obtain a ketone group-reduced styrene-based polymer;
(4) substituting the ketone group-reduced styrene-based polymer with quaternary ammonium to obtain a quaternary ammonium-substituted styrene-based polymer;
(5) reacting the quaternary ammonium-substituted styrene-based polymer with an aqueous basic solution so that the halogen ions ionically bound to quaternary ammonium may be substituted with hydroxide ions (OH⁻), thereby providing a styrene-based copolymer represented by the following Chemical Formula 1, 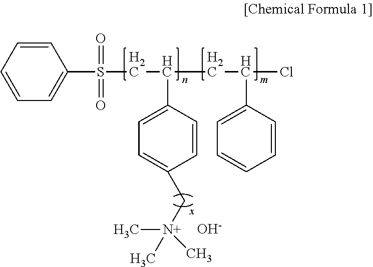
wherein x is an integer of 2-10, and
each of m and n represents the number of repeating units,
wherein the styrene-based copolymer has a molecular weight (Mₙ) of 5,000-200,000 q/mol; and
(6) dispersing the styrene-based copolymer in a mixed solvent including 25-400 parts by weight of water based on 100 parts by weight of alcohol.

2. (canceled)

3. The method of claim 1, wherein the polymerization in step (1) is carried out by any one of leaving radical polymerization, anion polymerization and cation polymerization.

4. The method of claim 1, wherein the reduction of ketone groups in step (3) is carried out by dissolving the acyl group-substituted styrene-based polymer in 1,2-dichloroethane and carrying out reaction with trifluoroacetic acid and triethylsilane.

5. The method of claim 4, wherein a step of mixing the ketone group-reduced styrene-based polymer with a basic solution to perform neutralization is further carried out, after completing the reduction of ketone groups.

6-8. (canceled)

9. A method for manufacturing a membrane electrode assembly for a solid alkaline fuel cell according to claim 1, which comprises the steps of:
mixing the electrode binder for a solid alkaline fuel cell, a catalyst, water and a solvent to prepare catalyst electrode slurry, the catalyst is selected from the group consisting of Ni, Aq, and Cu; and
coating the catalyst electrode slurry directly on an electrolyte membrane to obtain a membrane electrode assembly.

10. The method for manufacturing a membrane electrode assembly for a solid alkaline fuel cell according to claim 9, wherein the coating is selected from the group consisting of spray coating, catalyst coated membrane (CCM) coating and catalyst coated gas diffusion media (CCG) coating.

11. (canceled)
